(19) United States
(12) Patent Application Publication
(10) Pub. No.: US 2005/0106548 A1
(43) Pub. Date: May 19, 2005

(54) Interactive book to aid in recognizing and developing various emotional states

(76) Inventors: Andrea Goodman Weiner, New Hope, PA (US); Judith L. Jacobson, Gwynedd Valley, PA (US); Tammy Russeck, Doylestown, PA (US)

Correspondence Address: Wendy W. Koba, PO Box 556, Springtown, PA, 18081, US

(21) Appl. No.: 10/963,321

(22) Filed: Oct. 12, 2004

Related U.S. Application Data
(60) Provisional application No. 60/509,888, filed on Oct. 9, 2003.

(51) Int. Cl. G09B 19/00

(52) U.S. Cl. 434/317

(57) ABSTRACT

A teaching aid in the form of an interactive electronic book includes a number of pages illustrating different life situation scenes (e.g., classroom, doctor's office, etc.), each scene including an opening for a free-standing face to be inserted, in the way a puzzle piece is inserted in a picture. The electronic book contains a plurality of different removable faces, preferably stored within an easily accessible portion of the rear cover, each face expressing a different emotion (“happy”, “sad”, “afraid”, etc.). The user can then remove the “face” that best defines his/her feelings about the life illustration on the page currently being viewed. Additional features include a touch-sensitive area allowing for a recorded definition of each emotion to be played, and a “game spinner” to arbitrarily determine the particular life situation page to be explored.

### CROSS-REFERENCE TO RELATED APPLICATION

The present application claims the benefit and priority of Provisional Application No. 60/509,888, filed Oct. 9, 2003.

### TECHNICAL FIELD

The present invention relates to a developmental “interactive book” and, more particularly, to an interactive electronic book that aids in developing emotional intelligence in a young child.

### BACKGROUND OF THE INVENTION

The term “emotional intelligence” was first used in 1990 by Peter Salovey and John Mayer, two psychologists interested in understanding people beyond the well-known metric of one's “intelligence quotient” (IQ). Five years later, this concept was popularized in the book Emotional Intelligence, by Daniel Goleman. Goleman defined emotional intelligence as “abilities such as being able to motivate oneself and persist in the face of frustrations; to control impulse and delay gratification, to regulate one's moods, and keep distress from swamping the ability to think, to empathize, and to hope”. Simply put, emotional intelligence is the collection of emotional qualities that guide us in how we feel, think and take action in our lives. Emotional intelligence determines how we interact with people and our own self-awareness.

As IQ is to intelligence, so “EQ” is synonymous with “emotional” intelligence. A significantly important difference between IQ and EQ is that EQ is less genetically determined. For children, this means that their EQ can be influenced to a greater extent (and thus, increased) by their parents or other caregivers, particularly since a child's brain continues to grow, particularly between the ages of three and eight. Research in brain physiology has shown that all individuals have components in the brain that comprise the “emotional brain” and the “thinking brain”. Children can learn approaches that can trigger the circuits between the emotional brain and the thinking brain, allowing these children to grow in their emotional skills. The goal of emotional intelligence is to have both brains partner together and effectively interact to enhance a child's overall well-being.

A national study compared the emotional well-being of children in the mid-70's to that of children at the end of the 80's. The study found that by the time of 1988-1989, children had more worries and were more unhappy, anxious, depressed and ill-tempered than their counterparts from the 1970's. This rise in the number of children with emotional problems, accompanied by a breakdown of the children's emotional skills, has been attributed, at least in part, to family instability and violence in society and the media.

### SUMMARY OF THE INVENTION

The present invention is directed to a teaching aid for developing emotional intelligence in a young child. In particular, the teaching aid is in the form of an interactive, electronic “book”, containing a number of scenes of different life situations. Contained within the book is a set of sturdy, removable faces, each face expressing a different emotion (e.g., “happy”, “sad”, “angry”, “scared”, “proud”). One or more openings for these faces are formed in each life situation scene, allowing the child to insert the face with which he/she associates into different places in the scene. For example, if a child is experiencing difficult in adjusting to school, that child may insert a face expressing the emotion of “scared” into a schoolroom scene.

In one embodiment of the present invention, the removable faces comprise a set of cartoon-like character representations with which a child may have become familiar from other emotional learning-based teaching aids. In contrast, life-like children's faces expressing the desired emotions may be used.

As an additional feature, the interactive electronic book of the present invention may include a record/playback mechanism to allow a child to record his/her own statements regarding emotional states. Further, a touch-activated copy of each removable face may be disposed at the bottom of each receptacle for the removable faces, where upon removal of one of the faces a child may touch the picture and hear a recorded statement associated with that particular emotional state.

Various other aspects and features of the present invention may best be understood by reference to the following description and the associated drawings.

### BRIEF DESCRIPTION OF THE DRAWINGS

Referring now to the drawings, where like numerals represent like parts in several views:

FIG. 1 is an isometric illustration of the interactive electronic book of the present invention, shown with the book in its “open” position and its removable faces in their respective receptacles;

FIG. 2 is another isometric illustration of the same open pages of the interactive electronic book of FIG. 1, with one of the faces inserted within the scene, exposing the touch-sensitive copy of the face at the bottom of the receptacle; and

FIG. 3 illustrates an isometric view of an alternative embodiment of the interactive electronic book of the present invention, including accessories to further enhance the interaction between a young child and the electronic book.

### DETAILED DESCRIPTION

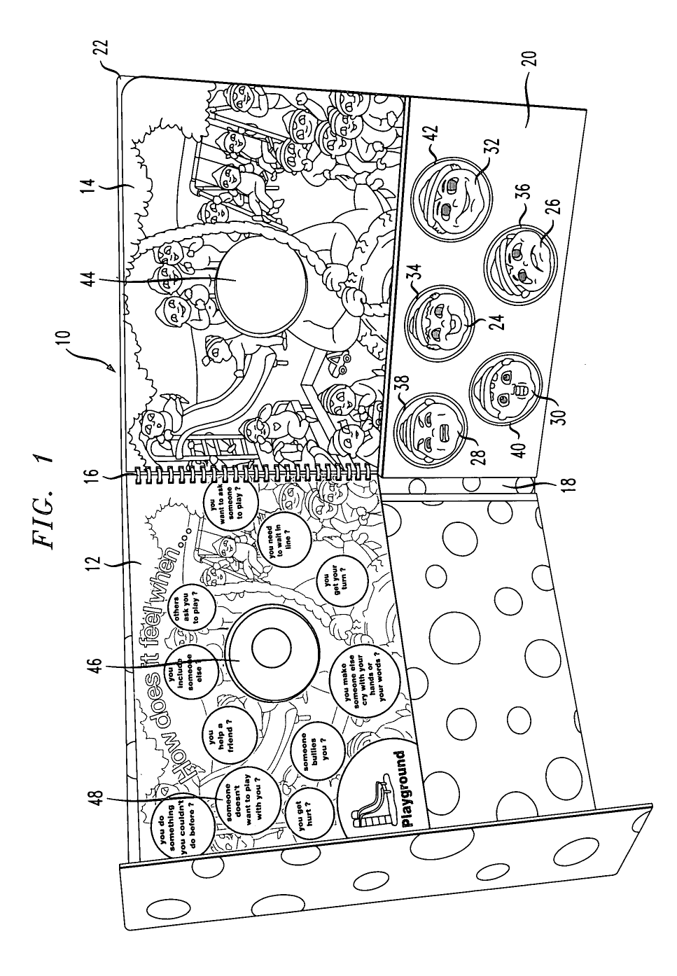

FIG. 1 contains an isometric view of an interactive electronic book 10, formed in accordance with the present invention, to be used as a teaching aid for developing emotional intelligence, particularly well-suited for use with young children. Referring to FIG. 1, interactive electronic book 10 is shown as opened to a pair of pages 12 and 14 (it is to be understood that the reference numerals “12” and “14” are used to refer to the specific elements within this embodiment of the present invention and not to the page numbers per se), where in most preferred embodiments interactive book 10 will include a large number of pages. The pages are preferably formed of a relatively stiff material, such as a heavy-duty plastic or paperboard. A hinge 16 is illustrated as used to bind the pages, where hinge 16 is attached to a spine 18 of interactive book 10. All of the pages in electronic book 10, as shown by pages 12 and 14, are “partial” pages in that the pages (as well as hinge 16) do not extend along the full length of spine 18.

In accordance with the present invention, an interior portion 20 of rear cover 22 of interactive book 10 is formed as a holding area for a plurality of removable faces, each face expressing a different emotion. In the particular embodiment of FIG. 1, holding portion 20 includes a set of five removable faces, with a face 24 illustrating the emotion of “happy”, face 26 illustrating the emotion of “sad”, face 28 illustrating the emotion of “angry”, face 30 illustrating the emotion of “scared”, and face 32 illustrating the emotion of “proud”. Each removable face is disposed within a separate opening formed within interior portion 20, with face 24 inserted within a first opening 34, face 26 inserted within an opening 36, face 28 inserted within an opening 38, face 30 inserted within an opening 40, and face 32 inserted within an opening 42. Each removable face piece comprises a relatively sturdy material, preferably the same material as used to form the pages of book 10, where the faces are disposed within their associated openings such that a young child may easily remove the face from the opening. While the illustrated faces are shown as cartoon-like, it is to be understood that more lifelike images of children expressing these various emotions may also be used. (e.g., “happy”, “sad”, “angry”, “scared”, “proud”).

The exemplary pair of pages 12 and 14 is illustrated as associated with a playground as the life situation. Of course, other pages will illustrate various other scenes such as, for example, a classroom, a bedroom, a kitchen, school bus, etc. Moreover, the particular illustrations may be determined on an “age appropriate” basis, with different scenes (different editions of the inventive interactive electronic book) used for different age levels. Page 14 is shown as containing an illustration of an exemplary playground scene, with an opening 44 formed in the face region on a child illustrated in the foreground of the scene. In accordance with the present invention, a young child may view this playground scene and then insert the face that illustrates the emotion this particular child experiences when at a playground. Thus, by allowing a child to view the scene, as well as the various facial expressions of a set of emotional responses, the child may learn to associate different emotions with different life experiences and allow a parent, caregiver or teacher working with the child to better understand that particular child's thoughts and feelings in different situations.

The opposing page 12 may contain, in one embodiment, a different life situation scene. However, in a preferred embodiment, as shown in FIG. 1, page 12 contains a number of statements regarding different scenarios that may be played out in the companion life situation scene. As illustrated in FIG. 1, this page contains the phrase How does it feel when . . . across the top, with various statements to end this phrase displayed around the page. An opening 46 is formed in page 12 so that a child may insert the face that best displays his/her emotion associated with the response to the prompt. For example, if the prompt is How does it feel when someone doesn't want to play with you? (see statement 48 as illustrated on page 12), the child may respond by inserting the “sad” face 26 in opening 46 on page 12.

By virtue of the design of the interactive book 10 of the present invention, the pages may be turned to display different scenes, while the lower portion 20 of back cover 22 remains in place, allowing the same of faces to be used with each scene. It is to be understood that this particular arrangement is considered to be exemplary, with other arrangements of the pages and the immovable portion of rear cover within the scope of the invention. For example, the immovable portion of rear cover 22 may be formed downward along the right-hand margin of the cover, in this arrangement with the pages being full length along spine 18, but shortened in width across rear cover 22. In general, as long as the portion of the book associated with holding the plurality of faces remains exposed to as to be used for interaction as the pages are turned, any arrangement may be used.

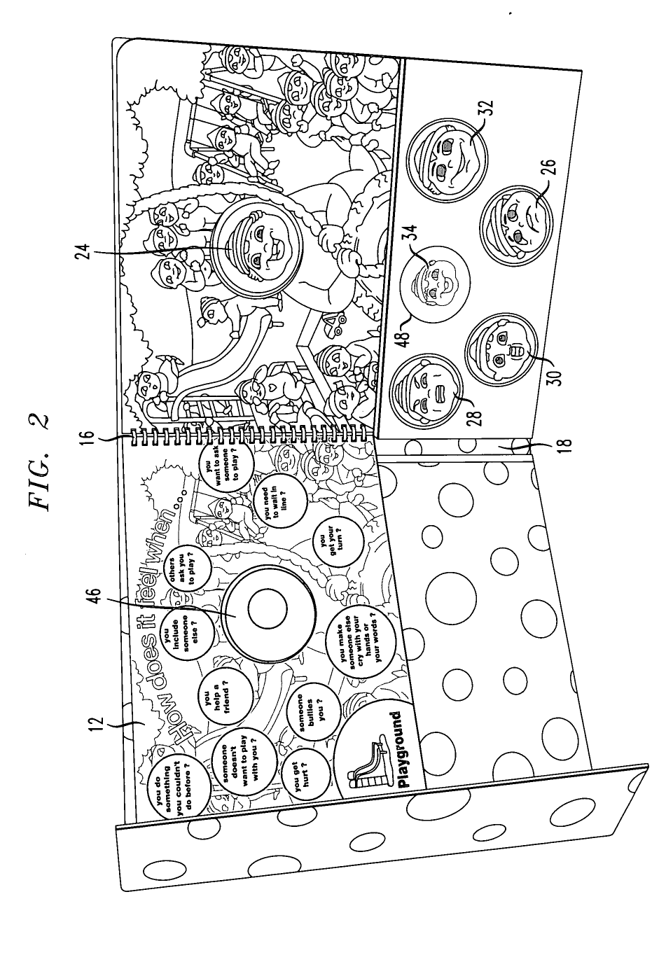

FIG. 2 illustrates the same isometric view of book 10, as opened to pages 12 and 14, but in the view of FIG. 2 one of the removable faces has been inserted within the foreground opening 44 in page 14. In the particular embodiment as shown in FIG. 2, face 24 (which illustrates the emotion of “happy”) has been inserted within opening 44. Thus, the child interacting with this particular portion of electronic book 10 has indicated that being on a playground is a pleasant experience for him/her. Obviously, another child may use a different face (exhibiting a different emotion) when confronted with this life situation scene. Once face 24 has been removed from its associated opening 34, the bottom surface 48 of opening 34 is shown as containing an identical illustration of the same face (so as to allow for the child to return the face to the proper opening). Preferably, surface 48 is touch sensitive so that as a child pushes a finger against surface 48 a recording is played that includes a statement associated with the particular emotion illustrated on the associated removable face. For example, when “happy” face 24 is removed and surface 48 is pressed, the recording may say “When I feel Happy, I can share my toys with others ”. Inasmuch as portion 20 of rear cover 22 is immovable while the pages are turned to illustrate various different life situations, the particular recorded statements associated with each emotion are intended to be general, not including specifics as would be required if the statement were to be related to a particular life situation scene.

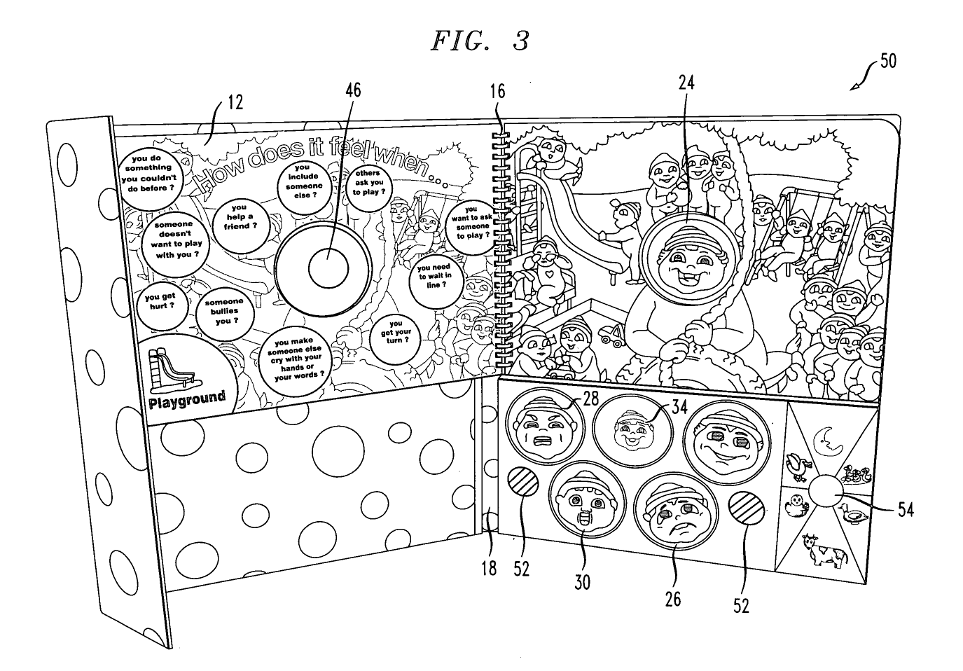

FIG. 3 contains an isometric view of an alternative interactive electronic book 50 formed in accordance with the present invention. Those elements within book 50 that are essentially identical to the elements within the embodiment of FIG. 1 carry over the same reference numerals from the earlier figure. In the particular embodiment as illustrated in FIG. 3, electronic book 50 further includes a record/playback mechanism 52 that allows for a child using the interactive book to record a personal statement, such as “I feel afraid when my mommy leaves me at school”, and play the recording for an adult working the child that is viewing a page illustrating a classroom setting. A “spinner” 54 is further illustrated as included on rear cover 22, where the spinner contains a small illustration of each life situation scene included within interactive book 50. The use of a spinner to select a particular scene to view may encourage a child to “deal with” a particularly difficult situation by not permitting the child to repeatedly view and interact with a page/scene with which the child is comfortable.

The interactive nature of the electronic book of the present invention is intended to be a fun way to teach young children how to appropriately express their emotions. When frustrations are expressed with anger or hurt (for example, with statements starting with “you”), the other person is put on the defensive. The interactive technique of the present invention allows for “I” messages to be used by a child, thereby enabling children to clearly and effectively communicate their feelings. By taking responsibility for their feelings, the “I” message opens the means for communication in a non-confrontational and responsible manner. Further, the use of “I” messages allows others to listen more openly. Benefits of using the “I” message for teachers include at least the following: clearer communications, a more positive classroom atmosphere, and more verbal participation. Benefits to the children include, among others: giving and receiving constructive feedback, greater permission and safety for expression of feelings, more responsible behavior and a more positive classroom atmosphere. Inasmuch as the inventive interactive electronic book may be used in a wide variety of circumstances and may depict such a wide variety of different life situations, it is to be understood that all of these variations are considered to fall within the spirit and scope of the present invention as defined by the claims appended hereto.

1. A teaching aid for facilitating the recognition and development of a plurality of different emotional states, the teaching aid comprising an interactive electronic book including
a front cover;
a rear cover, the rear cover including an immovable portion formed along a section of the outer perimeter thereof;
a plurality of life situation pages, each page having a scene illustrating a different life situation and an opening in the face area of a child illustrated in the scene, the plurality of life situation pages disposed between the front cover and the rear cover such that the immovable portion of the rear cover remains exposed as the pages are turned; and
a plurality of removable faces, each face disposed within a separate opening in the immovable portion of the rear cover, each face illustrating a different emotion and capable of being removed from the immovable portion and inserted in the opening in a displayed life situation page.

2. The teaching aid as defined in claim 1 wherein the immovable portion of the rear cover is disposed along at least a portion of the bottom edge of the rear cover.

3. The teaching aid as defined in claim 1 wherein the immovable portion of the rear cover is disposed along at least a portion of the top edge of the rear cover.

4. The teaching aid as defined in claim 1 wherein the immovable portion of the rear cover is disposed along at least a portion of the outer side edge of the rear cover.

5. The teaching aid as defined in claim 1 wherein the plurality of separate openings within the immovable portion of the rear cover include illustrations of the various emotions of the associated removable faces on the bottom surfaces thereof.

6. The teaching aid as defined in claim 5 wherein each bottom surface illustration is touch-activated to generate a recorded phrase associated with the illustrated emotion.

7. The teaching aid as defined in claim 1 wherein the teaching aid further comprises a playback/record mechanism.

8. The teaching aid as defined in claim 1 wherein the teaching aid further comprises a game spinner component disposed within the rear cover, the game spinner for selecting a particular life situation page.

9. The teaching aid as defined in claim 1 wherein the teaching aid further comprises
a plurality of prompting pages, each prompting page associated with a separate one of the life situation pages and further comprising an opening for the insertion of a removable face that best defines a user's response to one of a set of prompts displayed on said prompting page.
